(19) United States
(12) Patent Application Publication
(10) Pub. No.: US 2026/0042659 A1
(43) Pub. Date: Feb. 12, 2026

(54) LIQUID STORAGE ASSEMBLY, SPREADING MECHANISM, AND POOL ROBOT

(71) Applicant: XINGMAI INNOVATION TECHNOLOGY (SUZHOU) CO., LTD., Suzhou (CN)

(72) Inventor: Shilei ZHANG, Suzhou (CN)

(73) Assignee: XINGMAI INNOVATION TECHNOLOGY (SUZHOU) CO., LTD., Suzhou (CN)

(21) Appl. No.: 19/364,339

(22) Filed: Oct. 21, 2025

Related U.S. Application Data
(63) Continuation of application No. PCT/CN2023/114796, filed on Aug. 24, 2023.

(30) Foreign Application Priority Data
Apr. 28, 2023 (CN) 2023210064184

(51) Int. Cl. B67D 3/00

(52) U.S. Cl. CPC B67D 3/0061

(57) ABSTRACT

This application provides a liquid storage assembly, a spreading mechanism, and a pool robot. The liquid storage assembly includes a flexible liquid storage unit and a liquid filling nozzle. The flexible liquid storage unit is configured to accommodate a reagent. A liquid filling opening is disposed on the flexible liquid storage unit. The liquid filling nozzle is disposed at the liquid filling opening. A reagent is filled into or discharged from the flexible liquid storage unit through the liquid filling nozzle under an external force. The liquid storage assembly is conveniently assembled and maintained, and the spreading mechanism and the pool robot can spread the reagent evenly.

### CROSS REFERENCE TO RELATED APPLICATIONS

This application is a continuation of International Patent Application No. PCT/CN2023/114796, filed with the World Intellectual Property Organization on Aug. 24, 2023, which claims priority to Chinese Patent Application No. 2023210064184, filed with the China National Intellectual Property Administration on Apr. 28, 2023 and entitled “SPREADING MECHANISM AND POOL ROBOT”, which is hereby incorporated by reference herein.

### TECHNICAL FIELD

This application relates to the technical field of pool robots, and in particular, to a liquid storage assembly, a spreading mechanism, and a pool robot.

### BACKGROUND

Currently, a reagent used to maintain water quality of a swimming pool is usually manually spread. However, according to a manual spreading manner, there is a problem that the reagent is unevenly spread.

After the reagent is manually spread, a circulation system of the swimming pool needs to be used to drive the reagent to flow in water of the swimming pool, to maintain the water quality of the swimming pool. However, time and labor are consumed due to use of the circulation system of the swimming pool.

### SUMMARY

This application provides a liquid storage assembly. The liquid storage assembly includes: a flexible liquid storage unit configured to accommodate a reagent, where a liquid filling opening is disposed on the flexible liquid storage unit; and a liquid filling nozzle disposed at the liquid filling opening, where a reagent is filled into or discharged from the flexible liquid storage unit through the liquid filling nozzle under an external force.

Optionally, the liquid filling nozzle is a one-way valve.

Optionally, the liquid filling nozzle includes: a fixing portion disposed at the liquid filling opening, where a first channel and a second channel are disposed in the fixing portion, and an end of the first channel communicates with the flexible liquid storage unit, where the end is away from the second channel; and a drive portion, where at least a part of the drive portion is movably disposed at a communicating end configured to allow the second channel to communicate with the first channel, so that the drive portion moves to enable the first channel to communicate or dis-communicate with the second channel.

Optionally, the fixing portion includes: a first fixing portion, where the second channel is disposed in the first fixing portion; and a second fixing portion, where a first end of the second fixing portion is connected to the first fixing portion, a second end of the second fixing portion extends into the flexible liquid storage unit, the first channel is disposed in the second fixing portion, and the drive portion is movably disposed relative to the first fixing portion and the second fixing portion.

Optionally, a cross-sectional area of a flow cross section of the first channel is greater than a cross-sectional area of a flow cross section of the second channel to form a step structure between the first channel and the second channel, and at least a part of the drive portion is attached to a step end surface of the step structure, so that the first channel is disconnected to the second channel.

Optionally, the drive portion includes a first end and a second end opposite to each other. The first end of the drive portion is located in the first channel to form a water flow channel between the drive portion and an inner wall surface of the first channel. The second end of the drive portion is located in the second channel, and the second end of the drive portion is in clearance fit with the second channel to form a flow gap between the second end of the drive portion and an inner wall surface of the second channel. A position-limiting protrusion is disposed on the drive portion. The position-limiting protrusion extends in a perimetrical direction of the drive portion, and the drive portion is movably disposed in an extension direction of the first channel and the second channel, so that the position-limiting protrusion is attached to or separated from the step end surface, enabling the drive portion to block the first channel from communicating with the second channel or allow the first channel to communicate with the second channel.

Optionally, the liquid filling nozzle further includes a sealing member sleeved on and fixedly connected to the drive portion. The sealing member is located below the position-limiting protrusion. At least a part of the sealing member is attached to the inner wall surface of the second channel, so that the drive portion is at a blocking position.

Optionally, the liquid filling nozzle further includes a reset member. One end of the reset member is sleeved on the first end of the drive portion, the other end of the reset member is connected to the inner wall surface of the first channel, and the reset member is elastically disposed to push, under an elastic recovery force of the reset member, the drive portion to move to the blocking position.

Optionally, the liquid filling nozzle includes: a first fixing portion disposed at the liquid filling opening and sealingly connected to the liquid filling opening; a second fixing portion at least partially embedded in the first fixing portion, where the first fixing portion and the second fixing portion jointly form a water flow hole in an enclosing manner, where the water flow hole is configured to allow the liquid filling opening to communicate with the outside, and the water flow hole includes a first hole section disposed in the second fixing portion and a second hole section disposed in the first fixing portion; a drive portion, where a position-limiting step is disposed on the first fixing portion, a position-limiting protrusion is disposed on the drive portion, and the drive portion passes through the water flow hole; a reset member sleeved on the drive portion and disposed between the position-limiting protrusion and the second fixing portion in an axis direction of the water flow hole; and a sealing member sleeved on the drive portion. When the drive portion is at an initial position, the sealing member is sealed between the position-limiting protrusion and the position-limiting step under a driving force of the reset member. When the drive portion is pushed under an external force in the axis direction of the water flow hole, the reset member is compressed, so that the position-limiting protrusion is separated from the position-limiting step, and liquid flows out of the flexible liquid storage unit and then is discharged after sequentially flowing through the first hole section and a gap between the drive portion and the second hole section.

Optionally, the liquid filling nozzle further includes an end cap. The end cap covers an end of the first fixing portion, where the end is away from the second fixing portion.

Optionally, the liquid storage assembly further includes an outer casing configured to accommodate the flexible liquid storage unit. A mounting hole is disposed on the outer casing, and the liquid filling nozzle passes through the mounting hole and protrudes from the outer casing.

Optionally, a through hole is disposed on the outer casing.

Optionally, the outer casing includes: a bottom plate configured to support the flexible liquid storage unit, where the mounting hole is disposed on the bottom plate; and a housing, where the housing is connected to the bottom plate to form a storage cavity configured to accommodate the flexible liquid storage unit.

Optionally, a through hole is disposed on the bottom plate.

Optionally, a through hole is disposed on a side wall of the housing.

Optionally, a handheld portion is disposed on the housing, and the handheld portion is a groove structure or a handle.

Optionally, a plurality of protrusions are disposed on one of a side wall of the housing and the bottom plate, and a plurality of buckles are disposed on the other one of the side wall of the housing and the bottom plate. The plurality of protrusions are spaced from each other in a perimetrical direction of the side wall or the bottom plate. The plurality of buckles are spaced from each other in a perimetrical direction of the bottom plate or the side wall. Each buckle is clamped with each protrusion.

Optionally, a plurality of sleeves are further disposed on the side wall of the housing or the bottom plate that is provided with the protrusions. The plurality of sleeves are disposed in a one-to-one correspondence with the protrusions, so that when the housing is assembled with the bottom plate, each buckle passes through each sleeve, and each protrusion is clamped with each buckle.

This application further provides a spreading mechanism. The spreading mechanism includes: the above liquid storage assembly and a spreading drive assembly communicating with a liquid filling nozzle and configured to drive a reagent to be discharged from a flexible liquid storage unit of the liquid storage assembly to be spread.

This application further provides a pool robot including the above spreading mechanism.

### BRIEF DESCRIPTION OF THE DRAWINGS

To describe technical solutions in embodiments of this application more clearly, the following briefly introduces the accompanying drawings required for describing embodiments of this application. It is clear that the accompanying drawings in the following description show merely some embodiments of this application, and a person of ordinary skill in the art may still derive other drawings from the content of embodiments of this application and these accompanying drawings without creative efforts.

FIG. 1 is an exploded diagram of a structure of a liquid storage assembly according to an embodiment of this application;

FIG. 2 is a schematic diagram of a cross-sectional structure of a liquid storage assembly according to an embodiment of this application;

FIG. 3 is an enlarged view of a portion A in FIG. 2;

FIG. 4 is a schematic diagram of a structure of a liquid storage assembly according to an embodiment of this application.

### REFERENCE NUMERALS

1000: liquid storage assembly; 100: flexible liquid storage unit; 110: liquid filling opening; 200: liquid filling nozzle; 210: first fixing portion; 211: water flow hole; 212: position-limiting step; 220: second fixing portion; 230: drive portion; 231: position-limiting protrusion; 240: reset member; 250: sealing member; 260: end cap; 271: first channel; 272: second channel; 300: outer casing; 310: bottom plate; 312: buckle; 3121: groove; 313: through hole; 320: housing; 321: protrusion; 322: sleeve; 330: handheld portion; 340: mounting hole.

### DETAILED DESCRIPTION

The following further describes this application with reference to the accompanying drawings and embodiments. It may be understood that the specific embodiments described herein are merely used to explain this application, but are not intended to limit this application. In addition, it should be noted that, for ease of description, only a part but not all of a structure related to this application is shown in the accompanying drawings.

In descriptions of this application, unless otherwise expressly specified and limited, the terms such as “link”, “connect”, and “fasten” should be understood broadly. For example, the term “connect” may indicate a fixed connection, a detachable connection, or an integral connection, may indicate a mechanical connection or an electrical connection, or may indicate a direct connection, an indirect connection implemented through an intermediate medium, or communication between internal structures of two elements or an interaction relationship between two elements. A person of ordinary skill in the art may understand specific meanings of the foregoing terms in this application based on a specific situation.

In this application, unless otherwise expressly specified and limited, that a first feature is “above” or “below” a second feature may be that the first feature may be in direct contact with the second feature, or the first feature may be in contact with the second feature through another feature between the first feature and the second feature instead of being in direct contact with the second feature. In addition, that the first feature is “above”, “on”, or “over” the second feature may be that the first feature is right above or obliquely above the second feature, or may merely mean that a horizontal height of the first feature is greater than that of the second feature. That the first feature is “below”, “underneath”, or “under” the second feature may be that the first feature is right below or obliquely below the second feature, or may merely mean that a horizontal height of the first feature is less than that of the second feature.

In descriptions of embodiments, an orientation or position relationship indicated by terms “above”, “below”, “left”, “right”, and the like is an orientation or position relationship based on the accompanying drawings, and is only intended to facilitate descriptions and simplify operations, but is not intended to indicate or imply that an apparatus or an element needs to have a specific orientation and be constructed and operated in a specific orientation. Therefore, such terms cannot be understood as a limitation on this application. In addition, the terms “first” and “second” are merely used to distinguish in description and have no special meaning.

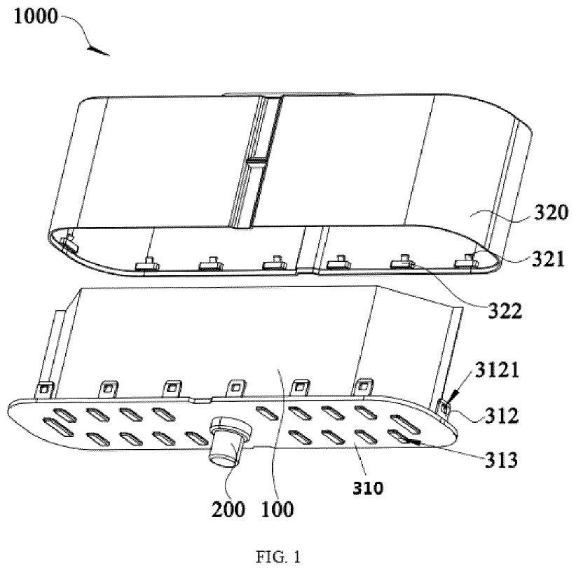

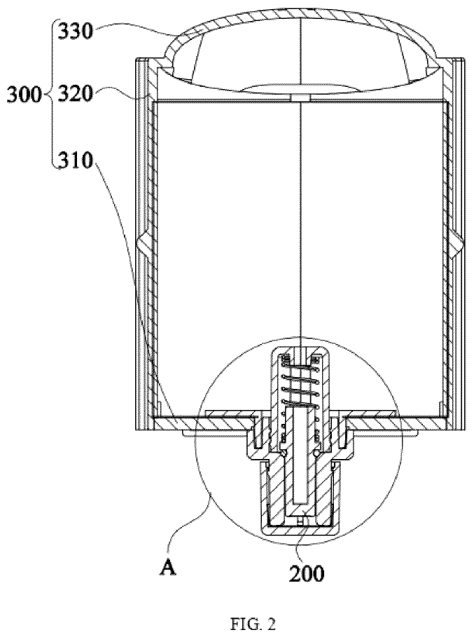

As shown in FIG. 1 to FIG. 4, an embodiment provides a liquid storage assembly 1000. The liquid storage assembly 1000 includes a flexible liquid storage unit 100 and a liquid filling nozzle 200. The flexible liquid storage unit 100 is configured to accommodate a reagent. A liquid filling opening 110 is disposed on the flexible liquid storage unit 100. A liquid filling nozzle 200 is disposed at the liquid filling opening 110. A reagent may be filled into or discharged from the flexible liquid storage unit 100 through the liquid filling nozzle 200 under an external force. A structure of the liquid storage assembly 1000 is simple. The liquid storage assembly 1000 is used in a spreading mechanism of a pool robot, and the reagent in the liquid storage assembly 1000 for maintaining water quality is spread into the pool, so that a problem that time and labor are consumed when the reagent is manually spread into the pool to maintain the water quality of the pool is resolved.

When the reagent in the flexible liquid storage unit 100 of the pool robot is discharged underwater, because the flexible liquid storage unit 100 is made of a flexible material, a volume of the flexible liquid storage unit 100 may be adjusted through deformation of the flexible liquid storage unit 100, so that the liquid storage assembly 1000 can be used in the pool robot even if the pool robot operates in an underwater environment. In this way, a problem in a related technology that a boxed structure accommodating a reagent for maintaining the water quality is not airtight, and pressure cannot be adjusted is resolved, and the spreading mechanism including the liquid storage assembly 1000 can operate underwater. In other words, when the pool robot moves in water, the reagent may be discharged from the liquid storage assembly 1000 and spread, and because the pool robot can move in the water of the pool, the reagent can be evenly spread in the water of the pool, so that the water quality of the pool can be maintained comprehensively, efficiently, and effectively.

In some embodiments, the liquid filling nozzle 200 includes a fixing portion and a drive portion 230. The fixing portion is disposed at the liquid filling opening 110. A first channel 271 and a second channel 272 are disposed in the fixing portion. An end of the first channel 271 communicates with the flexible liquid storage unit 100, where the end is away from the second channel 272. At least a part of the drive portion 230 is movably disposed at a communicating end configured to allow the second channel 272 to communicate with the first channel 271, so that the drive portion 230 moves to enable the first channel 271 to communicate or dis-communicate with the second channel 272.

Specifically, the fixing portion includes a first fixing portion 210 and a second fixing portion 220. The second channel 272 is disposed in the first fixing portion 210. A first end of the second fixing portion 220 is connected to the first fixing portion 210. A second end of the second fixing portion 220 extends into the flexible liquid storage unit 100. The first channel 271 is disposed in the second fixing portion 220. The drive portion 230 is movably disposed relative to the first fixing portion 210 and the second fixing portion 220.

Specifically, a cross-sectional area of a flow cross section of the first channel 271 is greater than a cross-sectional area of a flow cross section of the second channel 272 to form a step structure between the first channel 271 and the second channel 272, and at least a part of the drive portion 230 is attached to a step end surface of the step structure, so that the first channel 271 is disconnected to the second channel 272.

Specifically, the drive portion 230 includes a first end and a second end opposite to each other. The first end of the drive portion 230 is located in the first channel 271 to form a water flow channel between the drive portion 230 and an inner wall surface of the first channel 271. The second end of the drive portion 230 is located in the second channel 272, and the second end of the drive portion 230 is in clearance fit with the second channel 272 to form a flow gap between the second end of the drive portion 230 and an inner wall surface of the second channel 272. A position-limiting protrusion 231 is disposed on the drive portion 230. The position-limiting protrusion 231 extends in a perimetrical direction of the drive portion 230, and the drive portion 230 is movably disposed in an extension direction of the first channel 271 and the second channel 272, so that the position-limiting protrusion 231 is attached to or separated from the step end surface, enabling the drive portion 230 to block the first channel 271 from communicating with the second channel 272 or allow the first channel 271 to communicate with the second channel 272.

Specifically, the liquid filling nozzle 200 further includes a sealing member 250 sleeved on and fixedly connected to the drive portion 230. The sealing member 250 is located below the position-limiting protrusion 231. At least a part of the sealing member 250 is attached to the inner wall surface of the second channel 272, so that the drive portion 230 is at a blocking position.

Optionally, the sealing member 250 is a sealing ring.

Specifically, the liquid filling nozzle 200 further includes a reset member 240. One end of the reset member 240 is sleeved on the first end of the drive portion 230, the other end of the reset member 240 is connected to the inner wall surface of the first channel 271, and the reset member 240 is elastically disposed to push, under an elastic recovery force of the reset member 240, the drive portion 230 to move to the blocking position.

In some embodiments, the liquid filling nozzle 200 is a one-way valve. When the liquid storage assembly 1000 is not mounted on the spreading mechanism, the one-way valve is in a closed state, so that the reagent is prevented from leaking during transportation or in other states. After the liquid storage assembly 1000 is mounted on the spreading mechanism, the one-way valve is opened, so that liquid can flow out.

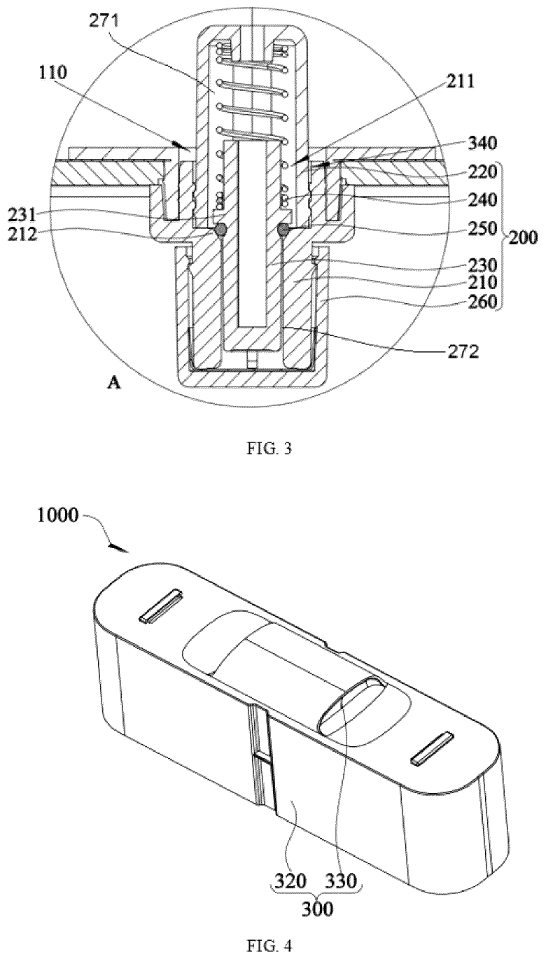

Specifically, as shown in FIG. 3, the one-way valve includes the first fixing portion 210, the second fixing portion 220, the drive portion 230, the reset member 240, and the sealing member 250. The first fixing portion 210 is disposed at the liquid filling opening 110 and sealingly connected to the liquid filling opening 110. The second fixing portion 220 is at least partially embedded in the first fixing portion 210. The first fixing portion 210 and the second fixing portion 220 jointly form a water flow hole 211 in an enclosing manner. The water flow hole 211 is configured to allow the liquid filling opening 110 to communicate with the outside. The water flow hole 211 includes a first hole section disposed in the second fixing portion 220 and a second hole section disposed in the first fixing portion 210. A position-limiting step 212 is disposed on the first fixing portion 210. The position-limiting protrusion 231 is disposed on the drive portion 230. The drive portion 230 passes through the water flow hole 211. The reset member 240 is sleeved on the drive portion 230 and disposed between the position-limiting protrusion 231 and the second fixing portion 220 in an axis direction of the water flow hole 211. The sealing member 250 is sleeved on the drive portion 230. When the drive portion 230 is at an initial position, the sealing member 250 is sealed between the position-limiting protrusion 231 and the position-limiting step 212 under a driving force of the reset member 240. When the drive portion 230 is pushed under an external force in the axis direction of the water flow hole 211, the reset member 240 is compressed, so that the position-limiting protrusion 231 is separated from the position-limiting step 212, and liquid flows out of the flexible liquid storage unit 100 and then is discharged after sequentially flowing through the first hole section and a gap between the drive portion 230 and the second hole section.

It should be noted that the first hole section is the first channel 271, and the second hole section is the second channel 272.

In addition, the one-way valve further includes an end cap 260. During transportation or storage, the end cap 260 covers an end of the first fixing portion 210, where the end is away from the second fixing portion 220, to provide protection.

When the spreading mechanism is in operation, the liquid filling nozzle 200 is disposed downward, so that the reagent can be discharged more easily. However, because the flexible liquid storage unit 100 is made of a flexible material, the flexible liquid storage unit 100 is prone to deformation. To improve structural stability of the liquid storage assembly 1000, as shown in FIG. 1, the liquid storage assembly 1000 further includes an outer casing 300 configured to accommodate the flexible liquid storage unit 100. A mounting hole 340 is disposed on the outer casing 300, and the liquid filling nozzle 200 passes through the mounting hole 340 and protrudes from the outer casing 300.

In some embodiments, a through hole 313 is disposed on the outer casing 300. When the reagent in the flexible liquid storage unit 100 is reduced, enabling the flexible liquid storage unit 100 to be deformed, the liquid in the pool can enter a housing 320 through the through hole 313, so that an overall weight of the pool robot basically remains unchanged after the reagent is reduced. This improves moving stability of the pool robot in the water.

Specifically, the outer casing 300 includes a bottom plate 310 and a housing 320. The bottom plate 310 is configured to support the flexible liquid storage unit 100. The mounting hole 340 is disposed on the bottom plate 310. The housing 320 is connected to the bottom plate 310 to form a storage cavity configured to accommodate the flexible liquid storage unit 100. This helps remove and mount the liquid storage assembly 1000 by a user and protect the flexible liquid storage unit 100, to avoid damage or leakage during transportation and storage. In this way, safety of the liquid storage assembly 1000 can be improved and ensured.

The bottom plate 310 can support the flexible liquid storage unit 100. The mounting hole 340 is disposed on the bottom plate 310, the mounting hole 340 is disposed opposite to the liquid filling opening, and the liquid filling nozzle 200 passes through the mounting hole 340 and protrudes from the bottom plate 310, so that an outlet of the liquid filling nozzle 200 is located below the flexible liquid storage unit 100, and the reagent in the flexible liquid storage unit 100 can be discharged more easily through the liquid filling nozzle 200 under gravity. This reduces a residue of the reagent and avoids waste.

In some embodiments, a plurality of protrusions 321 are disposed on a side wall of the housing 320, the plurality of protrusions 321 are spaced from each other in a perimetrical direction of the side wall, a plurality of buckles 312 are disposed on the bottom plate 310, and the plurality of buckles 312 are spaced from each other in a perimetrical direction of the bottom plate 310. Each buckle 312 is clamped with each protrusion 321, so that the housing 320 is connected to the bottom plate 310.

In some embodiments, the protrusion 321 may alternatively be disposed on the bottom plate 310, and the buckle 312 may be disposed on the housing 320. Structures and effects of the protrusion 321 and the buckle 312 are the same as those described above. Details are not described herein again.

Specifically, a groove 3121 is disposed on the buckle 312. When the housing 320 is assembled with the bottom plate 310, the protrusion 321 is clamped with the groove 3121. This helps improve stability of connection between the buckle 312 and the protrusion 321 and prevents the housing 320 from being separated from the bottom plate 310.

Specifically, a plurality of sleeves 322 are further disposed on the housing 320 that is provided with the protrusions 321. The plurality of sleeves 322 are disposed in a one-to-one correspondence with the protrusions 321, so that when the housing 320 is assembled with the bottom plate 310, each buckle 312 passes through each sleeve 322, and each protrusion 321 is clamped with each buckle 312. This further improves the stability of connection between the housing 320 and the bottom plate 310. When the protrusion 321 is disposed on the bottom plate 310, the sleeve 322 is disposed on the bottom plate 310.

In some embodiments, the housing 320 may alternatively be fixed to the bottom plate 310 through screw fastening, ultrasonic welding, thermal conductive welding, gluing, or the like.

Optionally, a through hole 313 may be disposed on the bottom plate 310. When the pool robot leaves a water surface, liquid in the housing 320 can be discharged through the through hole 313, so that the liquid can be quickly discharged from the pool robot. The liquid in the housing 320 can be completely discharged through the through hole 313 located on the bottom plate 310, to avoid a residue of the liquid. Whether there is a reagent remaining in the flexible liquid storage unit 100 may be determined based on gravity of the liquid storage assembly 1000. After the liquid in the housing 320 is discharged, the user can continue to fill the flexible liquid storage unit 100 with a reagent, so that the liquid storage assembly 1000 can be repeatedly used. This reduces costs.

Alternatively, a through hole 313 is disposed on a side wall of the housing 320, or a through hole 313 is disposed on each of the bottom plate 310 and a side wall of the housing 320. An effect of the through hole 313 is the same as that described above. Details are not described herein again.

Optionally, a handheld portion 330 or a handle may be further disposed on the housing 320 to facilitate assembling or detaching of the liquid storage assembly 1000. The handheld portion 330 may be a groove disposed on the housing 320.

This application further provides a spreading mechanism including the above liquid storage assembly 1000.

Specifically, the spreading mechanism further includes a spreading drive assembly (not shown in the figure). The spreading drive assembly is disposed outside a housing. The spreading drive assembly communicates with a liquid filling nozzle 200 and is configured to drive a reagent to be discharged from a flexible liquid storage unit 100 to be spread. For example, the spreading drive assembly may be a water pump. The water pump is a conventional liquid pumping structure for ease of implementation.

This application further provides a pool robot. The pool robot includes the above spreading mechanism, a moving assembly, a drive assembly, and a control module. The moving assembly is disposed at an output end of the drive assembly to drive the pool robot to move in water, so that the pool robot can perform cleaning in the water and maintain a pool to implement pool maintenance. The drive assembly is electrically connected to the control module to implement automatic control. This improves intelligence of the pool robot. The spreading mechanism is configured as a module in the pool robot, thereby facilitating assembly and maintenance. In addition, the spreading mechanism is added without changing an original structure of a water path of an existing pool robot, thereby facilitating implementation.

It should be noted that the foregoing shows and describes basic principles and main features of this application and advantages of this application. A person skilled in the art should understand that this application is not limited to the foregoing embodiments, the foregoing embodiments and this specification only describe principles of this application, and various changes and modifications may be made to this application without departing from the spirit and scope of this application. These changes and modifications fall within the protection scope claimed in this application. The protection scope claimed in this application is defined by the appended claims and equivalents thereof.

What is claimed is:

1. A liquid storage assembly, comprising:
a flexible liquid storage unit configured to accommodate a reagent, wherein a liquid filling opening is disposed on the flexible liquid storage unit;
a liquid filling nozzle disposed at the liquid filling opening, wherein a reagent is filled into or discharged from the flexible liquid storage unit through the liquid filling nozzle under an external force; and
an outer casing configured to accommodate the flexible liquid storage unit, wherein a through hole is disposed on the outer casing.

2. The liquid storage assembly according to claim 1, wherein the liquid filling nozzle is a one-way valve.

3. The liquid storage assembly according to claim 1, wherein the liquid filling nozzle comprises:
a fixing portion disposed at the liquid filling opening, wherein a first channel and a second channel are disposed in the fixing portion, and an end of the first channel communicates with the flexible liquid storage unit, wherein the end is away from the second channel; and
a drive portion, wherein at least a part of the drive portion is movably disposed at a communicating end configured to allow the second channel to communicate with the first channel, so that the drive portion moves to enable the first channel to communicate or dis-communicate with the second channel.

4. The liquid storage assembly according to claim 3, wherein the fixing portion comprises:
a first fixing portion, wherein the second channel is disposed in the first fixing portion; and
a second fixing portion, wherein a first end of the second fixing portion is connected to the first fixing portion, a second end of the second fixing portion extends into the flexible liquid storage unit, the first channel is disposed in the second fixing portion, and the drive portion is movably disposed relative to the first fixing portion and the second fixing portion.

5. The liquid storage assembly according to claim 4, wherein a cross-sectional area of a flow cross section of the first channel is greater than a cross-sectional area of a flow cross section of the second channel to form a step structure between the first channel and the second channel, and at least a part of the drive portion is attached to a step end surface of the step structure, so that the first channel is disconnected to the second channel.

6. The liquid storage assembly according to claim 5, wherein:
the drive portion comprises a first end and a second end opposite to each other, wherein the first end of the drive portion is located in the first channel to form a water flow channel between the drive portion and an inner wall surface of the first channel; and the second end of the drive portion is located in the second channel, and the second end of the drive portion is in clearance fit with the second channel to form a flow gap between the second end of the drive portion and an inner wall surface of the second channel; and
a position-limiting protrusion is disposed on the drive portion, wherein the position-limiting protrusion extends in a perimetrical direction of the drive portion, and the drive portion is movably disposed in an extension direction of the first channel and the second channel, so that the position-limiting protrusion is attached to or separated from the step end surface, enabling the drive portion to block the first channel from communicating with the second channel or allow the first channel to communicate with the second channel.

7. The liquid storage assembly according to claim 6, wherein the liquid filling nozzle further comprises:
a sealing member sleeved on and fixedly connected to the drive portion, wherein the sealing member is located below the position-limiting protrusion, wherein at least a part of the sealing member is attached to the inner wall surface of the second channel, so that the drive portion is at a blocking position.

8. The liquid storage assembly according to claim 7, wherein the liquid filling nozzle further comprises:
a reset member, wherein one end of the reset member is sleeved on the first end of the drive portion, the other end of the reset member is connected to the inner wall surface of the first channel, and the reset member is elastically disposed to push, under an elastic recovery force of the reset member, the drive portion to move to the blocking position.

9. The liquid storage assembly according to claim 1, wherein the liquid filling nozzle comprises:
a first fixing portion disposed at the liquid filling opening and sealingly connected to the liquid filling opening;
a second fixing portion at least partially embedded in the first fixing portion, wherein the first fixing portion and the second fixing portion jointly form a water flow hole in an enclosing manner, wherein the water flow hole is configured to allow the liquid filling opening to communicate with the outside, and the water flow hole comprises a first hole section disposed in the second fixing portion and a second hole section disposed in the first fixing portion;
a drive portion, wherein a position-limiting step is disposed on the first fixing portion, a position-limiting protrusion is disposed on the drive portion, and the drive portion passes through the water flow hole;
a reset member sleeved on the drive portion and disposed between the position-limiting protrusion and the second fixing portion in an axis direction of the water flow hole; and
a sealing member disposed on the drive portion, wherein when the drive portion is at an initial position, the sealing member is sealed between the position-limiting protrusion and the position-limiting step under a driving force of the reset member, and when the drive portion is pushed under an external force in the axis direction of the water flow hole, the reset member is compressed, so that the position-limiting protrusion is separated from the position-limiting step, and liquid flows out of the flexible liquid storage unit and then is discharged after sequentially flowing through the first hole section and a gap between the drive portion and the second hole section.

10. The liquid storage assembly according to claim 9, wherein the liquid filling nozzle further comprises an end cap, wherein the end cap covers an end of the first fixing portion, wherein the end is away from the second fixing portion.

11. The liquid storage assembly according to claim 1, wherein a mounting hole is disposed on the outer casing, and the liquid filling nozzle passes through the mounting hole and protrudes from the outer casing.

12. The liquid storage assembly according to claim 11, wherein the outer casing comprises:
a bottom plate configured to support the flexible liquid storage unit, wherein the mounting hole is disposed on the bottom plate; and
a housing, wherein the housing is connected to the bottom plate to form a storage cavity configured to accommodate the flexible liquid storage unit.

13. The liquid storage assembly according to claim 12, wherein the through hole is disposed on the bottom plate.

14. The liquid storage assembly according to claim 12, wherein the through hole is disposed on a side wall of the housing.

15. The liquid storage assembly according to claim 12, wherein a handheld portion is disposed on the housing, and the handheld portion is a groove structure or a handle.

16. The liquid storage assembly according to claim 12, wherein a plurality of protrusions are disposed on one of a side wall of the housing and the bottom plate, and a plurality of buckles are disposed on the other one of the side wall of the housing and the bottom plate, wherein the plurality of protrusions are spaced from each other in a perimetrical direction of the side wall or the bottom plate, the plurality of buckles are spaced from each other in a perimetrical direction of the bottom plate or the side wall, and each buckle is clamped with each protrusion.

17. The liquid storage assembly according to claim 16, wherein a plurality of sleeves are further disposed on the side wall of the housing or the bottom plate that is provided with the protrusions, wherein the plurality of sleeves are disposed in a one-to-one correspondence with the protrusions, so that when the housing is assembled with the bottom plate, each buckle (312) passes through each sleeve (322), and each protrusion is clamped with each buckle.

18. A spreading mechanism, comprising:
the liquid storage assembly according to claim 1; and
a spreading drive assembly communicating with a liquid filling nozzle and configured to drive a reagent to be discharged from a flexible liquid storage unit of the liquid storage assembly to be spread.

19. A pool robot, comprising the spreading mechanism according to claim 18.
